(19) United States
(12) Patent Application Publication
(10) Pub. No.: US 2020/0176811 A1
(43) Pub. Date: Jun. 4, 2020

(54) LITHIUM SOLID-STATE CONDUCTOR, LITHIUM BATTERY INCLUDING THE CONDUCTOR, AND METHODS OF MANUFACTURE THEREOF

(71) Applicant: SAMSUNG ELECTRONICS CO., LTD., Suwon-si (KR)

(72) Inventors: Yan Wang, Brookline, MA (US); Lincoln Miara, Lincoln, MA (US); Jeong-Ju Cho, Lexington, MA (US)

(73) Assignee: SAMSUNG ELECTRONICS CO., LTD., Suwon-si (KR)

(21) Appl. No.: 16/439,970

(22) Filed: Jun. 13, 2019

Related U.S. Application Data
(60) Provisional application No. 62/773,354, filed on Nov. 30, 2018.

(51) Int. Cl. H01M 10/0562; H01M 4/485; H01M 2/16; H01M 10/0525; H01M 4/36; C01G 41/00; C01B 21/082

(52) U.S. Cl. CPC H01M 10/0562; H01M 4/485; H01M 2/1686; H01M 10/0525; H01M 2004/028; H01M 2/1646; C01G 41/006; C01B 21/0828; H01M 4/366

(57) ABSTRACT

A compound of Formula 1

Li_{((2+(6-a)α)+(b-2)γ)}W_{(1-α)}M^{a}_{α}O_{(4-γ-δ)}A^{b}_{γ} (1)

wherein M is at least one cationic element with valence of a, A is an anion having a valence of −b, δ is a content of oxygen vacancies, 3≤a≤5, 1≤b≤3, 0≤α≤0.5, 0≤γ≤0.3, and 0≤δ≤0.1.

### CROSS-REFERENCE TO RELATED APPLICATION

This application claims priority to U.S. Provisional Patent Application No. 62/773,354, filed on Nov. 30, 2018, in the United States Patent and Trademark Office, and all the benefits accruing therefrom under 35 U.S.C. § 119, the content of which is incorporated herein in its entirety by reference.

### BACKGROUND

### 1. Field

Disclosed is a lithium solid-state conductor, a lithium battery including the conductor, and methods of manufacture thereof.

### 2. Description of the Related Art

Lithium batteries are of interest because they can potentially offer improved specific energy and energy density, improved safety, and in some configurations improved power density. However, currently available materials are not sufficiently stable to lithium metal. Also, the lithium conductivity of available solid-state electrolytes is significantly less than liquid alternatives. Thus there remains a need for an improved solid-state lithium electrolyte, and an electrochemical cell including the same.

### SUMMARY

Disclosed is a compound of Formula 1

Li_{((2+(6-a)α)+(b-2)γ)}W_{(1-α)}M^{a}_{α}O_{(4-γ-δ)}A^{b}_{γ} (1)

wherein M is at least one cationic element with valence of a, A is an anion having a valence of −b, δ is a content of oxygen vacancies, 3≤a≤5, 1≤b≤3, 0≤α≤0.5, 0≤γ≤0.3, and 0≤δ≤0.1.

Also disclosed is an electrolyte composition, the composition including the compound of Formula 1.

Also disclosed is a separator including: a microporous film; and the compound of Formula 1 on the microporous film.

Also disclosed is a positive electrode active material including a lithium transition metal oxide; and the compound of Formula 1 on a surface of the lithium transition metal oxide.

Also disclosed is a lithium battery, including a negative electrode; a separator; and a positive electrode, wherein the separator is between the negative electrode and the positive electrode, and wherein the separator includes the compound of Formula 1.

Also disclosed is a method of manufacturing the compound of Formula 1, the method including: contacting a compound comprising lithium, a compound comprising tungsten, and optionally a compound comprising element M and element A to form a mixture; and heat-treating the mixture to manufacture the compound of Formula 1.

Also disclosed is a method of manufacturing the lithium battery, the method including: providing a negative electrode; providing a positive electrode; disposing the compound of Formula 1 on at least one of the positive electrode and the negative electrode; and disposing the negative electrode on the positive electrode to manufacture the lithium battery.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is an illustration of an aspect of a structure of the lithium tungstate of Formula 1;

FIG. 2 is a schematic illustration of an aspect of a battery;

FIG. 3 is a graph of lithium diffusion coefficient (square centimeters per second) versus the inverse of temperature (1000/Kelvin) and is an Arrhenius plot illustrating lithium diffusion and the activation energy of Li_{2.25}W_{0.75}Ta_{0.25}O₄;

FIG. 4 is a graph of lithium uptake or loss per formula unit versus voltage (V versus Li/Li⁺) showing the intrinsic stability of Li₂WO₄; and

FIG. 5 is a graph of lithium uptake or loss per formula unit versus voltage (V versus Li/Li⁺) showing the intrinsic stability of Li_{2.25}W_{0.75}Ta_{0.25}O₄.

### DETAILED DESCRIPTION

Disclosed is a lithium tungstate of the Formula (1)

Li_{((2+(6-a)α)+(b-2)γ)}W_{(1-α)}M^{a}_{α}O_{(4-γ-δ)}A^{b}_{γ} (1)

wherein
M is at least one cationic element with valence of a,
A is an anion having a valence of −b,
δ is a content of oxygen vacancies,
3≤a≤5, 1≤b≤3, 0≤α≤0.5, 0≤γ≤0.3, and 0≤δ≤0.1.
   The disclosed compound has unexpectedly improved lithium conductivity and unexpected electrochemical stability, and provides improved stability in air. As is further disclosed herein, the disclosed lithium tungstate can be used to provide a solid-state lithium-ion battery. In an aspect, the compound of Formula 1 can be used alone to provide a solid-state electrolyte, or used in combination with another lithium conductive material to provide an electrolyte composition comprising the compound of Formula 1.

In Formula 1, M is at least one cationic element with valence of a. M may be Y, In, La, Sc, Zr, Ti, Hf, Sn, Si, Ge, Ta, Nb, or a combination thereof. In an aspect M may be Y³⁺, In³⁺, La³⁺, Sc³⁺, Zr⁴⁺, Ti⁴⁺, He+, Sn⁴⁺, Si⁴⁺, Ge⁴⁺, Ta⁵⁺, Nb⁵⁺, or a combination thereof. In an aspect M is pentavalent, and is Ta⁵⁺, Nb⁵⁺, or a combination thereof. In an aspect, M is tetravalent, and is Ti⁴⁺, Hf⁴⁺, Sn⁴⁺, Si⁴⁺, Ge⁴⁺, or a combination thereof. An embodiment in which M is Ta⁵⁺ is mentioned.

A content of M^{a} in Formula 1 may be 0≤α≤0.5, 0<α≤0.5, 0<α<0.5, or 0.1<α<0.4.

In Formula 1, A is an anion having a valence of −b. In an aspect, A is F, Cl, Br⁻, I, N, or a combination thereof. A may be F⁻, Cl⁻, Br⁻, I⁻, N³⁻, or a combination thereof. In an aspect, A is I⁻, N³⁻, or a combination thereof. An embodiment in which A is I⁻ is mentioned.

A content of A in Formula 1 may be 0≤γ≤0.3, 0<γ≤0.3, 0<γ<0.3, or 0.1<γ<0.2.

The compound of Formula 1 may comprise an oxygen vacancy. A content of the oxygen vacancy δ may be 0≤δ≤0.1, 0<δ≤0.1, 0<δ<0.1, or 0.01<δ<0.05.

In an aspect, the cationic element M is not used, and the anion is N³⁻, and the compound of Formula 1 may be represented by Formula 2.

Li_{(2+γ)}WO_{(4-γ-δ)}N_{γ} (2)

As noted above, γ may be 0≤γ≤0.3, and δ may be 0≤δ≤0.1.

In an aspect, the cationic element M is not used, and the anion is F⁻, Cl⁻, Br⁻, I⁻, or a combination thereof, and the compound of Formula 1 may be represented by Formula 3.

Li_{(2-γ)}WO_{(4-γ)}X_{γ} (3)

In Formula 3, X is F⁻, Cl⁻, Br⁻, I⁻, or a combination thereof. An embodiment in which X is F⁻ is mentioned.

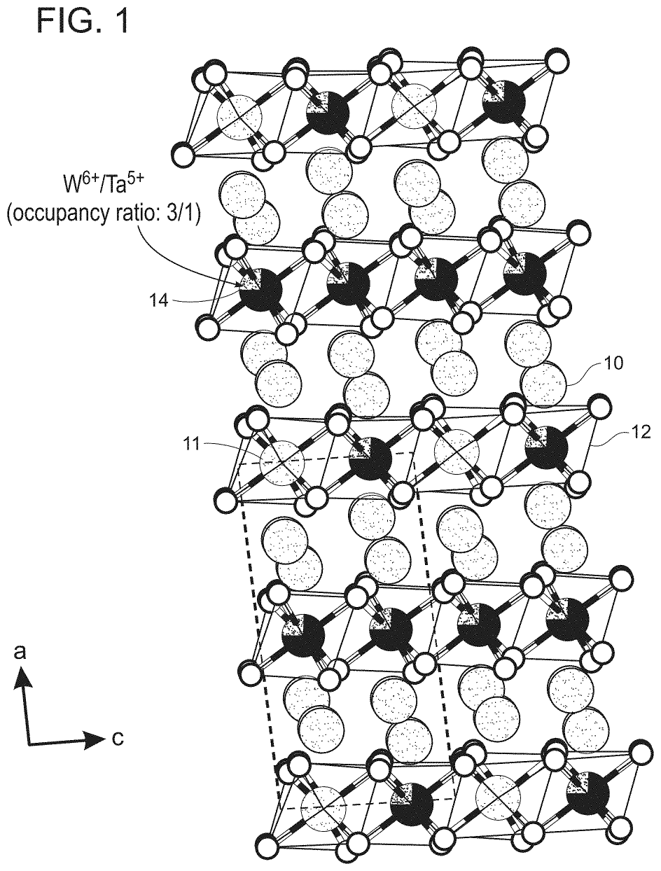

In an aspect, M is Ta, and the compound of Formula 1 has the formula Li_{2.25}W_{0.75}Ta_{0.25}O₄, equivalent to Li₉TaW₃O₁₆, and has the structure shown in FIG. 1, in which lithium 10 is disposed between layers of W centered oxygen octahedra 12. While not wanting to be bound by theory, it is understood that lithium 11 in excess of a stoichiometry of 2 in Formula 1 resides on tungsten crystallographic sites 14. Also, if the cationic element M^{a} is present, as shown for an aspect in which M is Ta⁵⁺ in FIG. 1, the cationic element is understood to also reside on the tungsten crystallographic sites. The cationic element M can compensate the charge of the lithium excess. The W⁶⁺ and the cationic element M occupy the W crystallographic sites with an occupancy ratio corresponding to the stoichiometry of W and M in the compound of Formula 1. For example, in Li_{2.25}W_{0.75}Ta_{0.25}O₄, the W and Ta occupy the W crystallographic sites with an occupancy ratio of 3:1.

The compound of Formula 1 can be in the form of a particle, and can have, for example, a spherical form, an oval-spherical form, or the like. The particle diameter is not particularly limited, and a mean particle diameter ranging, for example, from 0.01 to 30 μm, for example, 0.1 to 20 μm is mentioned. A mean particle diameter refers to a number average diameter (D50) of the particle size distribution of particles obtained by scattering, or the like. The solid electrolyte can be prepared, for example, by mechanical milling to provide a suitable particle size.

In an aspect the compound of Formula 1 can be combined with a lithium conductive material to provide an electrolyte composition comprising compound of Formula 1. The lithium conductive material can comprise a glass, a ceramic, or a combination thereof. The lithium conductive material can comprise a sulfide solid electrolyte or an oxide solid electrolyte, such as a garnet-type solid state electrolyte.

The sulfide solid electrolyte may comprise Li₂S—P₂S₅, Li₂S—P₂S₅—LiX, wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, wherein m and n are positive numbers, Z is one of Ge, Zn or Ga, Li₂S—GeS₂, Li₂S—SiS₂—Li₃PO₄, Li₂S—SiS₂-LiₚM¹O_{q} wherein p and q are positive numbers, M¹ is P, Si, Ge, B, Al, Ga, or In, Li₇₋ₓPS₆₋ₓClₓ wherein 0<x<2, Li₇₋ₓPS₆₋ₓBrₓ wherein 0<x<2, or Li₇₋ₓPS₆₋ₓIₓ wherein 0<x<2. Mentioned are Li₆PS₅Cl, Li₆PS₅Br⁻, or Li₆PS₅I.

The oxide solid electrolyte may comprise Li_{1+x+y}AlₓTi₂₋ₓSi_{y}P_{3-y}O₁₂ wherein 0<x<2, 0≤y<3, BaTiO₃, Pb(Zr₍₁₋ₓ₎Tiₓ)O₃ wherein 0≤x≤|, Pb₁₋ₓLaₓZr_{1-y}Ti_{y}O₃ wherein 0≤x<1, 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, Li₃PO₄, LiₓTi_{y}(PO₄)₃ wherein 0<x<2, 0<y<3), LiₓAl_{y}Ti_{z}(PO₄)₃, 0<x<2, 0<y<1, 0<z<3), Li_{1+x+y}(Al₍₁₋ₘ₎Gaₘ)ₓ(Ti₍₁₋ₙ₎Geₙ)₂₋ₓSi_{y}P_{3-y}O₁₂ (0≤x≤1, 0≤y≤1, 0≤m≤1, and 0≤n≤1, LiₓLa_{y}TiO₃ wherein 0<x<2, 0<y<3, LiₓGe_{y}P_{z}S_{w} wherein 0<x<4, 0<y<1, 0<z<1, and 0<w<5, LiₓN_{y} wherein 0<x<4 and 0<y<2, SiS₂, LiₓSi_{y}S_{z} wherein 0<x<3, 0<y<2, 0<z<4, LiₓP_{y}S_{z} wherein 0<x<3, 0<y<3 and 0<z<7, Li₂O, LiF, LiOH, Li₂CO₃, LiAlO₂, a Li₂O—Al₂O₃—SiO₂—P₂O₅—TiO₂—GeO₂ ceramic, a garnet ceramics of the formula Li₃₋ₓLa₃M¹₂O₁₂ wherein M¹ is Te, Nb or Zr and x is an integer of 1 to 10, or a combination thereof. Mentioned is (La₁₋ₓLiₓ)TiO₃ (LLTO) wherein 0<x<1.

Mentioned is a garnet-type oxide. The garnet-type oxide can be of the formula Li₅₊ₓE₃(Me²_{z}Me²_{(2-z)})O_{d} wherein E is a trivalent cation; Me¹ and Me² are each independently one of a trivalent, tetravalent, pentavalent, and a hexavalent cation; 0<x≤3, 0≤z<2, and 0<d≤12; and O can be partially or totally substituted with a pentavalent anion, a hexavalent anion, a heptavalent anion, or a combination thereof. For example, E can be partially substituted with a monovalent or divalent cation. In another embodiment, for example, in the solid ion conductor, when 0<x≤2.5, E may be La and Me² can be Zr.

In an embodiment, the garnet-type oxide can be of the formula Li_{5+x+2y}(D_{y}E₃₋₇)(Me¹_{z}me²_{2-z})O_{d} wherein D is a monovalent or divalent cation; E is a trivalent cation; Me¹ and Me² are each independently a trivalent, tetravalent, pentavalent, or a hexavalent cation; 0<x+2y≤3, 0<y≤0.5, 0≤z<2, and 0<d≤12; and 0 can be partially or totally substituted with a pentavalent anion, a hexavalent anion, a heptavalent anion, or a combination thereof. The preferred number of moles of lithium per formula unit (Li-pfu) in the above formula is 6<(5+x+2y)<7.2, 6.2<(5+x+2y)<7, 6.4<(5+x+2y)<6.8. In the garnet-type oxides of the above formulas, D can comprise potassium (K), rubidium (Rb), cesium (Cs), calcium (Ca), barium (Ba), or strontium (Sr). In an embodiment, D is calcium (Ca), barium (Ba), or strontium (Sr). In the above formulas, Me can be a transition metal. For example, Me can be tantalum (Ta), niobium (Nb), yttrium (Y), scandium (Sc), tungsten (W), molybdenum (Mo), antimony (Sb), bismuth (Bi), hafnium (Hf), vanadium (V), germanium (Ge), silicon (Si), aluminum (Al), gallium (Ga), titanium (Ti), cobalt (Co), indium (In), Zinc (Zn), or chromium (Cr). Mentioned is Li_{6.5}La₃Zr_{1.5}Ta_{0.5}O₁₂.

A solid electrolyte comprising the compound of Formula 1 may be porous. The porous structure of the electrolyte can refer to an electrolyte having micro- and/or nanostructural features, e.g., microporosity and/or nanoporosity. For example, the porosity of the solid electrolyte comprising the compound of Formula 1 can be 10 to 90%, or 20 to 80%, or 30 to 70%, including all intermediate values and ranges. The porosity of the first solid electrolyte and the second solid electrolytes can be the same or different. As used herein, “pores” can also refer to “voids.”

The compound of Formula 1 can be combined with a liquid electrolyte. In an aspect, the liquid electrolyte is disposed in a pore of the solid electrolyte comprising the compound of Formula 1. The liquid electrolyte may comprise a polar aprotic solvent and a lithium salt. The polar aprotic solvent can be dimethylether, diethylether, dimethyl carbonate, diethyl carbonate, ethylmethyl carbonate, dipropyl carbonate, methylpropyl carbonate, ethylpropyl carbonate, ethylene carbonate, propylene carbonate, butylene carbonate, fluoroethylene carbonate, methyl acetate, ethyl acetate, n-propyl acetate, dimethylacetate, methyl propionate, ethyl propionate, γ-butyrolactone, decanolide, valerolactone, mevalonolactone, caprolactone, dibutyl ether, tetraglyme, diglyme, polyethylene glycol dimethylether, dimethoxy ethane, 2-methyl tetrahydrofuran, 2,2-dimethyl tetrahydrofuran, 2,5-dimethyl tetrahydrofuran, cyclohexanone, triethylamine, triphenylamine, triether phosphine oxide, acetonitrile, dimethyl formamide, 1,3-dioxolane, and sulfolane, but the organic solvent is not limited thereto and any suitable solvent can be used. In an embodiment, the solvent preferably comprises a carbonate ester, and more preferably comprises ethylene carbonate and propylene carbonate.

The lithium salt may comprise LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) in which the x and y are natural numbers, e.g., an integer of 1 to 20, LiCl, LiI, LiB(C₂O₄)₂, lithium bis(fluorosulfonyl)imide, or a combination thereof. The concentration of the lithium salt may be 0.1 to 2 molar (M), e.g., 0.5 to 1.3 M in the aprotic solvent.

Also disclosed is a method of manufacturing the compound of Formula 1. The method may comprise contacting a compound comprising lithium, a compound comprising tungsten, and if M or A in Formula 1 are used, a compound comprising element M and element A to form a mixture; and heat-treating the mixture to manufacture the compound of Formula 1.

In an aspect, a lithium halide, such as lithium fluoride, lithium bromide, lithium chloride, or lithium iodide may be used, and contacted with lithium tungstate, tungsten oxide, or a combination thereof and included in the mixture. If the cationic element M is included, an oxide of M, e.g., yttrium oxide, indium oxide, lanthanum oxide, scandium oxide, zirconium oxide, titanium oxide, hafnium oxide, tin oxide, silicon oxide, germanium oxide, tantalum oxide, niobium oxide, or a combination thereof, may be included in the mixture. Other sources of lithium, such as lithium carbonate, lithium hydroxide, lithium oxide, may be used.

In an aspect, the mixture may be milled or ground, may by compressed, and heat-treated at 50° C. to 800° C., 60° C. to 700° C., 70° C. to 600° C. for 0.1 hours to 200 hours, 1 hour to 150 hours, or 2 hours to 100 hours. The manufacture of the compound of Formula 1 may further comprise sintering, and the sintering may comprise treating at 400° C. to 1200° C., 450° C. to 1100° C., 500° C. to 1000° C. for 0.1 hours to 200 hours. The sintering may comprise sintering the compound in the form of a powder, or in the form a pellet provided by compressing the powder at 1 ton per square centimeter to 10 tons per square centimeter, optionally with 0.1 to 3 weight percent of a binder, such as polyvinyl alcohol.

The electrolyte composition comprising the compound of Formula 1 may be manufactured by contacting the compound of Formula 1 with the lithium conductive material. The contacting may comprise mixing, e.g., with planetary mixer, or milling, e.g., with a ball mill, if desired.

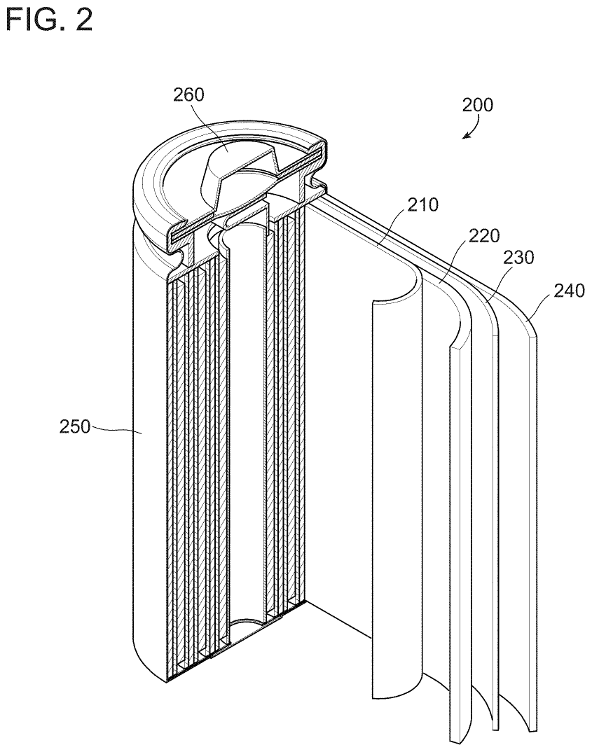

Also disclosed is a lithium battery, comprising: a negative electrode; a separator; and a positive electrode, wherein the separator is between the negative electrode and the positive electrode, and wherein the separator comprises the compound of Formula 1. An aspect of the lithium battery is shown in FIG. 2, which illustrates schematically a battery 200 comprising a negative electrode 210, a solid electrolyte 220, an optional separator 230 and a positive electrode 240. The electrode assembly may be disposed in a can 250 having a header 260.

The negative electrode may comprise a negative active material and optionally, a conductive agent, and a binder. A suitable negative active material includes a material capable of storing and releasing lithium ions electrochemically. A negative active material can include a carbon, such as a hard carbon, soft carbon, carbon black, Ketjen black, acetylene black, activated carbon, carbon nanotubes, carbon fiber, graphite, or an amorphous carbon. Also usable are lithium-containing metals and alloys, for example a lithium alloy comprising Si, Sn, Sb, Ge, or a combination thereof. Lithium-containing metal oxides, metal nitrides, and metal sulfides are also useful, in particular wherein the metal can be Ti, Mo, Sn, Fe, Sb, Co, V, or a combination thereof. Also useable are phosphorous (P) or metal doped phosphorous (e.g., NiP₃). The negative active material is not limited to the foregoing and any suitable negative active material can be used. In an embodiment the negative active material is disposed on a current collector, such as a copper current collector, to provide a negative electrode.

In an aspect, the negative electrode comprises graphite. In an aspect, the negative electrode comprises lithium metal or a lithium metal alloy. Use of lithium metal is mentioned.

The positive electrode comprises a positive active material layer comprising a positive active material and optionally a conductive agent and a binder.

The positive active material can comprise a lithium transition metal oxide, a transition metal sulfide, or the like. For example, the positive active material can include a composite oxide of lithium and a metal selected from cobalt, manganese, and nickel. For example, the positive active material can be a compound represented by any of the Formulas: LiₚM¹_{1-q}M²_{q}D₂ wherein 0.90≤p≤1.8 and 0≤q≤0.5; LiₚE_{1-q}M²_{q}O₂₋ₓDₓ wherein 0.90≤p≤1.8, 0≤q≤0.5, and 0≤x≤0.05; LiE_{2-q}M²_{q}O₄₋ₓDₓ wherein 0≤q≤0.5 and 0≤x≤0.05; LiₚNi_{1-q-r}Co_{q}M²ᵣDₓ wherein 0.90≤p≤1.8, 0≤q≤0.5, 0≤r≤0.05, and 0<x≤2; LiₚNi_{1-q-r}CoₚM²ᵣO₂₋ₓXₓ wherein 0.90≤p≤1.8, 0≤q≤0.5, 0≤r≤0.05, and 0<x<2; LiₚNi_{1-q-r}CoₚM²ᵣO₂₋ₓXₓ wherein 0.90≤p≤1.8, 0≤q≤0.5, 0≤r≤0.05, and 0<x<2; LiₚNi_{1-q-r}Mn_{q}M²ᵣDₓ wherein 0.90≤p≤1.8, 0≤q≤0.5, 0≤r≤0.05, and 0<x≤2; LiₚNi_{1-q-r}Mn_{q}M²ᵣO₂₋ₚXₓ wherein 0.90≤p≤1.8, 0≤q≤0.5, 0≤r≤0.05, and 0<x<2; LiₚNi_{1-q-r}Mn_{q}M²ᵣO^{2-x}Xₓ wherein 0.90≤p≤1.8, 0≤q≤0.5, 0≤r≤0.05, and 0<x<2; LiₚNi_{q}E^{r}G^{d}O₂ wherein 0.90≤p≤1.8, 0≤q≤0.9, 0≤r≤0.5, and 0.001≤d≤0.1; LiₚNi_{q}CoᵣMn_{d}GeO₂ wherein 0.90≤p≤1.8, 0≤q≤0.9, 0≤r≤0.5, 0≤d≤0.5, and 0.001≤e≤0.1; LiₚNiG_{q}O₂ wherein 0.90≤p≤1.8 and 0.001≤q≤0.1; LiₚCoG_{q}O₂ wherein 0.90≤p≤1.8 and 0.001≤q≤0.1; LiₚMnG_{q}O₂ where 0.90≤p≤1.8 and 0.001≤q≤0.1; LiₚMn₂G_{q}O₄ wherein 0.90≤p≤1.8 and 0.001≤q≤0.1; QO₂; QS₂; LiQS₂; V₂O₅; LiV₂O₂; LiRO₂; LiNiVO₄; Li_{(3-f)}O₂ (PO₄)₃ (0≤f≤2); Li_{(3-f)}Fe₂(PO₄)₃ wherein 0≤f≤2; and LiFePO₄, in which in the foregoing positive active materials M¹ is Ni, Co, or Mn; M² is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; and J is V, Cr, Mn, Co, Ni, or Cu. Examples of the positive active material include LiCoO₂, LiMnxO₂ₓ where x=1 or 2, LiNi₁₋ₓMnₓO₂ₓ where 0<x<1, LiNi_{1-x-y}CoₓMn_{y}O₂ where 0≤x≤0.5 and 0≤y≤0.5, LiFePO₄, TiS₂, FeS₂, TiS₃, and FeS₃.

Mentioned is an aspect in which the positive electrode material is a NCA material represented by LiₓNi_{y}E_{z}G_{d}O₂ (wherein 0.90≤x≤1.8, 0≤y≤0.9, 0≤z≤0.5, 0.001≤d≤0.1, E is Co, Mn, or a combination thereof, and G is Al, Cr, Mn, Fe, Mg, La, Ce, Sr, V, or a combination thereof). In an implementation, the positive active material may include, e.g., lithium cobalt oxide, lithium nickel cobalt manganese oxide, lithium nickel cobalt aluminum oxide, or a combination thereof.

Mentioned is a positive electrode active material comprising the lithium transition metal oxide; and the compound of Formula 1 on a surface of the lithium transition metal oxide. While not wanting to be bound by theory, it is understood that the compound of Formula 1 is effective to protect the positive electrode active material, e.g., to prevent or suppress reaction with the electrolyte.

The positive active material layer may further include a conductive agent and a binder. Any suitable conductive agent and binder may be used.

A binder can facilitate adherence between components of the electrode, such as the positive active material and the conductor, and adherence of the electrode to a current collector. Examples of the binder can include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. The amount of the binder can be in a range of about 1 part by weight to about 10 parts by weight, for example, in a range of about 2 parts by weight to about 7 parts by weight, based on a total weight of the positive active material. When the amount of the binder is in the range above, e.g., about 1 part by weight to about 10 parts by weight, the adherence of the electrode to the current collector may be suitably strong.

The conductive agent can include, for example, carbon black, carbon fiber, graphite, carbon nanotubes, graphene, or a combination thereof. The carbon black can be, for example, acetylene black, Ketjen black, Super P carbon, channel black, furnace black, lamp black, thermal black, or a combination thereof. The graphite can be a natural graphite or an artificial graphite. A combination comprising at least one of the foregoing conductive agents can be used. The positive electrode can additionally include an additional conductor other than the carbonaceous conductor described above. The additional conductor can be an electrically conductive fiber, such as a metal fiber; a metal powder such as a fluorinated carbon powder, an aluminum powder, or a nickel powder; a conductive whisker such as a zinc oxide or a potassium titanate; or a polyphenylene derivative. A combination comprising at least one of the foregoing additional conductors can be used.

The separator may be included between the positive electrode and negative electrode. In an embodiment the separator consists of the compound of Formula 1. In an aspect, the compound of Formula 1 may be combined with another lithium conductive material to provide a separator comprising the electrolyte composition comprising the compound of Formula 1 and the lithium conductive material. In an embodiment, the separator comprises a glass fiber, polyester, polyethylene, polypropylene, polytetrafluoroethylene (PTFE), or a combination thereof. In an embodiment the separator may comprise a microporous polymeric film, such as a microporous polyethylene or microporous polypropylene film. In an embodiment the separator comprises a micorporous olefin film, such as microporous polyethylene or polypropylene, and the compound of Formula 1 thereon. A diameter of a pore of the porous olefin film can be 0.01 to 10 micrometers (μm), and a thickness of the separator can be in a range of 5 to 300 μm.

In an aspect, the separator comprising the compound of Formula 1 may be porous. For example, a porous separator comprising the compound of Formula 1 may have a pore size of 1 to 50 μm, 2 to 40 μm, or 5 to 30 μm. The solid-state electrolyte may be liquid-impermeable, may be non-porous, or may have a pore size of 0.01 to 1 μm, or 0.05 to 0.5 μm.

The negative electrode can be produced from a negative active material composition including a negative active material, and optionally, the conductive agent, and the binder. In an embodiment the negative active material composition is disposed on a current collector, such as a copper current collector to form a negative electrode. Screen printing, slurry casting, or powder compression may be used, the details of which may be determined by one of skill in the art without undue experimentation and are not further elaborated upon herein for clarity.

Similarly, the positive electrode can be produced from a positive active material composition including a positive active material, and optionally, the conductive agent, and the binder. In an embodiment the positive active material composition is disposed on a current collector, such as an aluminum current collector to form a positive electrode. Screen printing, slurry casting, or powder compression may be used, the details of which may be determined by one of skill in the art without undue experimentation and are not further elaborated upon herein for clarity.

A lithium battery may be manufactured by providing a negative electrode; providing a positive electrode; disposing the compound of Formula 1 on at least one of the positive electrode and the negative electrode; and disposing the negative electrode on the positive electrode to manufacture the lithium battery.

In an aspect, a film comprising the compound of Formula 1 can be provided on a release layer, the film disposed on at least one of the negative electrode and the positive electrode, the release layer removed, and then the negative electrode disposed on the positive electrode to manufacture the lithium battery.

Various embodiments are shown in the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

### EXAMPLES

### Example 1. Phase Stability

The energy above hull is determined for compounds according to Formula 1. Compounds having an energy above hull of less than 65 millielectron volts (meV) per atom at a temperature between 450° C. to 800° C. are observed to be stable and included in Table 1.

TABLE 1

| | | Phase Stability |
|---|---|---|
| General | Example | (Energy Above |
| Composition | Compositions | the Convex Hull) |
| Li_{2+α}W_{1-α}M^{a}_{α}O₄ | Li_{2.0625}W_{0.9375}Ta_{0.0625}O₄ | 6.9 meV/atom |
| (M^{a} = Ta) | Li_{2.25}W_{0.75}Ta_{0.25}O₄ | 18.3 meV/atom |
| Li_{2+2α}W_{1-α}M^{a}_{α}O₄ | Li_{2.125}W_{0.9375}Hf_{0.0625}O₄ | 18.7 meV/atom |
| (M^{a} = Hf) | Li_{2.5}W_{0.75}Hf_{0.25}O₄ | 62.8 meV/atom |
| Li_{2+γ}WO_{4-γ}A_{γ} | Li_{2.0625}WO_{3.9375}N_{0.0625} | 19.3 meV/atom |
| (A = N³⁻) | Li_{2.125}WO_{3.875}N_{0.125} | 36.4 meV/atom |
| | Li_{2.1875}WO_{3.8125}N_{0.1875} | 53.9 meV/atom |
| Li_{2-γ}WO_{4-γ}A_{γ} | Li_{1.9375}WO_{3.9375}I_{0.0625} | 21.8 meV/atom |
| (A = I⁻) | Li_{1.875}WO_{3.875}I_{0.125} | 32.6 meV/atom |
| | Li_{1.8125}WO_{3.8125}I_{0.1875} | 57.0 meV/atom |

### Example 2. Activation Energy and Ionic Conductivity

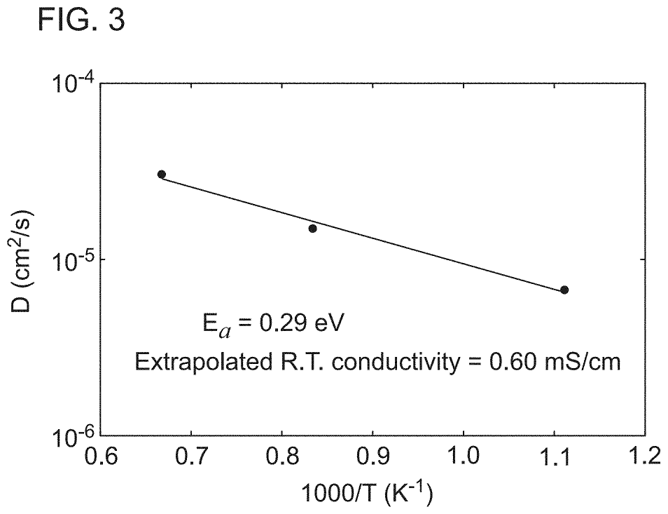

The activation energy and ionic diffusivity of the compound Li_{2.25}W_{0.75}Ta_{0.25}O₄ is determined at 600 Kelvin, 900 Kelvin, and 1200 Kelvin by ab initio molecular dynamics. The room temperature (300 Kelvin) ionic diffusivity is extrapolated from the results with elevated temperatures, and then converted to the ionic conductivity using the NernstEinstein relation. As shown in FIG. 3, Li_{2.25}W_{0.75}Ta_{0.25}O₄ provides an activation energy of 0.29 electron volts (eV) and an ionic conductivity at 300 Kelvin of 0.60 millisiemens per centimeter (mS/cm).

### Example 3. Electrochemical Stability

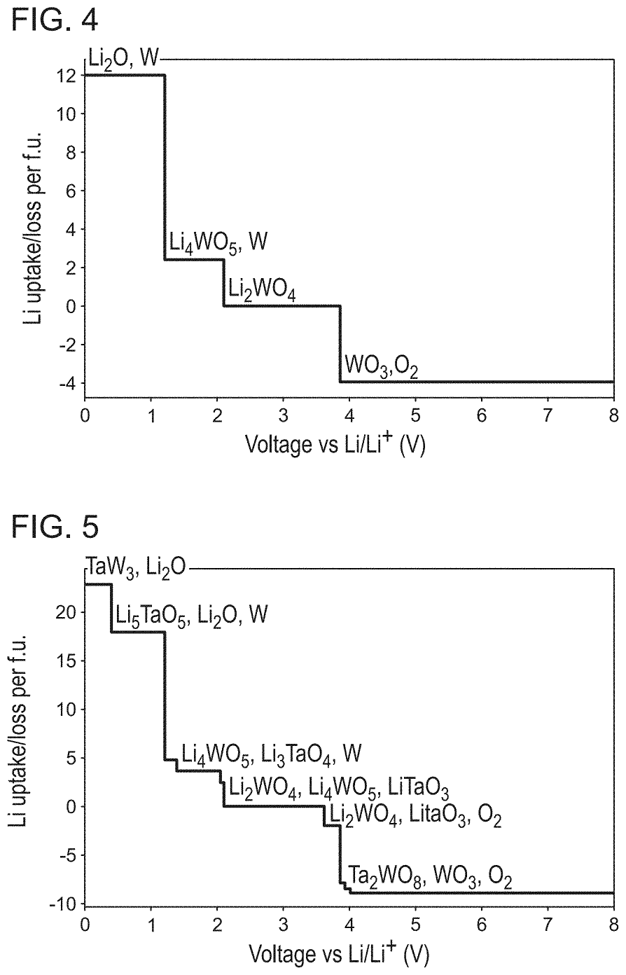

The stability of Li₂WO₄ and Li_{2.25}W_{0.75}Ta_{0.25}O₄ are evaluated between 0 and 8 volts versus Li/Li⁺, the results being shown in FIG. 4 for Li₂WO₄ and FIG. 5 for Li_{2.25}W_{0.75}Ta_{0.25}O₄. As shown in FIG. 4, Li₂WO₄ is intrinsically stable between 2.1 V and 3.87 V versus Li/Li⁺. Also, as shown in FIG. 5, Li₂WO₄ is intrinsically stable between 2.1 V and 3.67 V versus Li/Li⁺.

While a particular embodiment has been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A compound of Formula 1
Li_{((2+(6-a)α)+(b-2)γ)}W_{(1-α)}M^{a}_{α}O_{(4-γ-δ)}A^{b}_{γ} (1)
wherein
M is at least one cationic element with valence of a,
A is an anion having a valence of −b,
δ is a content of oxygen vacancies,
3≤a≤5, 1≤b≤3, 0≤α≤0.5, 0≤γ≤0.3, and 0≤δ≤0.1.

2. The compound of claim 1, wherein M is pentavalent.

3. The compound of claim 1, wherein M is Y, In, La, Sc, Zr, Ti, Hf, Sn, Si, Ge, Ta, Nb, or a combination thereof.

4. The compound of claim 1, wherein A is F, Cl, Br⁻, I, N, or a combination thereof.

5. The compound of claim 1, wherein in a crystal structure of the compound of Formula 1, a portion of the lithium resides on a W crystallographic site.

6. The compound of claim 1, wherein α=0.

7. The compound of claim 1, wherein the compound of Formula 1 is Li_{(2+γ)}WO_{(4-γ)}N_{γ}, wherein 0≤γ≤0.3.

8. The compound of claim 1, wherein the compound of Formula 1 is Li_{(2-γ)}WO_{(4-γ)}X_{γ}, wherein X is F⁻, Cl⁻, Br⁻, I⁻, or a combination thereof, and 0≤γ≤0.3.

9. An electrolyte composition, the composition comprising: the compound of claim 1.

10. A separator comprising:
a microporous film; and
the compound of Formula 1 on the microporous film.

11. A positive electrode active material comprising:
a lithium transition metal oxide; and
the compound of claim 1 on a surface of the lithium transition metal oxide.

12. A lithium battery, comprising:
a negative electrode;
a separator; and
a positive electrode,
wherein the separator is between the negative electrode and the positive electrode, and
wherein the separator comprises the compound of claim 1.

13. A method of manufacturing the compound of claim 1, the method comprising:
contacting a compound comprising lithium, a compound comprising tungsten, and optionally a compound comprising element M and element A to form a mixture; and
heat-treating the mixture to manufacture the compound of Formula 1.

14. A method of manufacturing the lithium battery, the method comprising:
providing a negative electrode;
providing a positive electrode;
disposing the compound of claim 1 on at least one of the positive electrode and the negative electrode; and
disposing the negative electrode on the positive electrode to manufacture the lithium battery.
